(19) United States
(12) Patent Application Publication
(10) Pub. No.: US 2009/0070267 A9
(43) Pub. Date: Mar. 12, 2009

(54) User programmed media delivery service

(75) Inventor: Rick Hangartner, Corvallis, OR (US)

Correspondence Address: Stolowitz Ford Cowger LLP, 621 SW Morrison St, Suite 600, Portland, OR, 97205, US

(73) Assignee: MusicStrands, Inc., Corvallis, OR (US)

(21) Appl. No.: 11/434,448

(22) Filed: May 12, 2006

Related U.S. Application Data
(60) Provisional application No. 60/730,599, filed on Oct. 26, 2005.
(60) Provisional application No. 60/722,750, filed on Sep. 30, 2005.

(51) Int. Cl. H04L 9/00

(52) U.S. Cl. 705/59

(57) ABSTRACT

A method and system for programming a media delivery system (FIG. 2) in which members of the general public can produce and host programming, including non-promotional (106) and promotional media items (108), and media consumers (220) can provide direct feedback (252, 262) to the operator of the media delivery system (200) indicating the programming and advertising of most interest to them. Appropriately licensed, copyright-protected media items, and optionally promotional media items, are made available through a web-based virtual production studio (200) to users (210) who may combine them with user-provided media items to produce programming suitable for transmission over the media delivery system.

### COPYRIGHT NOTICE

© 2006 Musicstrands, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

Applicant hereby incorporates by this reference the disclosures of commonly-owned U.S. Provisional Application Nos. 60/722,750 filed Sep. 30, 2005 and 60/730,599 filed Oct. 26, 2005 in their entireties as though fully set forth.

### TECHNICAL FIELD

The present invention relates to composing programming content for delivery to media consumers over a media delivery system such as an FCC-licensed broadcast channel, the internet, a cable television service, or a mobile phone service, and for providing feedback to the operator of user interest in the programming content.

### SUMMARY OF THE INVENTION

The disclosed invention in various embodiments can include systems, methods, and business processes, or any combination of them, which seek to adapt and expand user content-creation models, currently exemplified by podcasting and media-sharing websites, and a targeted advertising model, currently exemplified by internet websites which infer advertising items that might be of interest to a visitor based on the visitor's interactions with the website, to a traditionally advertising-supported media delivery service such as broadcast radio or television. Some embodiments of the invention will be applicable for realizing a similar media delivery service in the form of a streaming media service on the internet or over a mobile phone network.

In contrast to the prior art, one aspect of the disclosed invention enables users to produce programming in a virtual studio application operated by a media delivery system for distribution in the system. In one embodiment, the operator of the service secures just the necessary rights, such as just the performance rights for music items, to transmit the media items, and in this model user programmers can include media items in their programs for which they do not hold the necessary rights. In some embodiments, the operator of the service can insure that the content of user programs meet applicable licensing requirements. For example, a music broadcaster or streamer can insure that programs meet the “sound recording performance complement” constraints to qualify for the statutory performance license mandated by 17 U.S.C 114. Similarly, a broadcaster can insure that the media items available to programmers are in compliance with FCC decency standards.

In another aspect of the invention, the virtual studio in some embodiments also includes means for a user-programmer to suggest or select advertising items to be included in the programs produced by the user. The service may then solicit advertising traffic from individual advertisers or an advertisement broker responsive to the suggestions by user programmers, rather than solicit advertising in the conventional way based on audience size and demographic characteristics.

Yet another aspect of the invention enables users of the media distribution service to communicate their general and specific interests with regard to the advertising items they would like to see included in the media transmissions provided to them. In this way, users are more likely to be provided with advertising items likely to be of interest to them, thereby increasing the value of the media delivery service for both advertisers and users. In one embodiment, users may maintain a profile on a web-based service using a client application on the appropriate user media player device. In other embodiments, users may just indicate on a web-based service via a client application whether they have an interest in particular advertisement or would like to receive more advertisements from the same category as a particular advertisement.

In one embodiment, the media delivery service operator may aggregate this information to infer the preferences of the service audience for advertisers, and to select the promotional media items included in the media transmissions. Services which have a unique channel to each user, for example internet radio services and mobile network providers, could additionally use this information to replace audience-targeted advertisements in a media transmission to an individual user with promotional media items of specific interest to the user.

The disclosed invention in some embodiments further includes a method whereby users develop programs for transmission by a media delivery service, in part composed of media items licensed by the service, using a virtual studio application operated by the service. In some embodiments, the users can also provide indications of the types of advertising items that support the service which are, or would be, of most interest to them via a feedback means also operated by the media delivery service.

The disclosed invention also encompasses a system for programming the media content and advertising of a media delivery service that includes a virtual production studio hosted on a server system operated by the media delivery service and accessed by the user-programmer over a communications network. The server system includes a catalog of licensed media items available for user programmers to include along with content they supply in their programming. In some embodiments, the virtual studio includes means for a user to suggest or select advertising items to be included in the programming produced by the user. Finished programs, in the form of playlists, are then supplied over the communication network to a content transmission system such as, in different embodiments, a traditional radio or television broadcaster, an internet streaming service with a backing streaming media server, or a mobile phone network provider.

The system in one embodiment includes provision for audience members to indicate the media items and type of advertisements of most interest to them. This feature can be hosted, for example, on a server system operated by the media delivery service, and accessed by the user-programmer over a communications network such as the internet. In some embodiments, the means for accessing this mechanism for indicating individual advertising preferences might be included in conventional devices for accessing the media delivery service. For example, this feedback mechanism might be provided as a feature of a broadcast radio receiver equipped with a separate communication channel to the broadcast radio service.

In some embodiments, the disclosed invention further encompasses a business process for operating a media delivery system that invites customers of the system to program the media items transmitted by the system, and to participate directly and indirectly in the selection of the revenue-generating advertising that supports operation of the service as further explained below.

Reference is now made to the figures in which like reference numerals refer to like elements. For clarity, the first digit of a reference numeral indicates the figure number in which the corresponding element is first used. In the following description, certain specific details of programming, software modules, user selections, network transactions, database queries, database structures, etc., are provided by was of illustration and not limitation for a thorough understanding of the invention. However, those skilled in the art will recognize that the invention can be practiced without one or more of the specific details, or with other methods, components, materials, etc.

Some cases, well-known structures, materials, or operations are not shown or described in detail in order to avoid obscuring aspects of the invention. Furthermore, the described features, structures, or characteristics may be combined in any suitable manner in one or more embodiments. In general, the methodologies of the present invention are advantageously carried out using one or more digital processors, for example the types of microprocessors that are commonly found in PC's, laptops, PDA's and all manner of desktop or portable electronic appliances.

### BRIEF DESCRIPTION OF THE DRAWINGS

FIG. 1 is a descriptive diagram of one example of a business process in accordance with embodiments of the invention.

FIG. 2 is a system diagram that includes the illustrative components included in some embodiments of the invention.

FIG. 3 is a high-level flow diagram of one example of a method in accordance with the invention in which a user-programmer functions.

FIG. 4 is a high-level flow diagram of one example of a method in accordance with the invention in which a user accesses media provided by the media delivery system.

FIG. 5 is a high-level flow diagram of one example of a method in accordance with the invention in which an interactive media delivery service with a unique channel to each user, such as an internet streaming media service or a mobile network provider, provides media items to a user of the media delivery service.

FIG. 6 is a high-level flow diagram of one example of a method in accordance with the invention in which a non-interactive media delivery service which does not have a unique channel to each user, such as an FCC-licensed radio or television broadcaster, provides media items to a user of the media delivery service.

FIG. 7 is a high-level flow diagram of one example of a method in accordance with the invention in which an advertising service delivers ad items to be provided to a user of an interactive or non-interactive media delivery service.

FIG. 8 is a graphical depiction of one example of a business method in accordance with the invention by which a user produces and hosts programming provided by the media delivery system using a virtual studio website.

FIG. 9 is a graphical depiction of one example of a business method in accordance with the invention by which a user provides expressions of programming and advertising preferences to the media delivery service.

### DETAILED DESCRIPTION OF PREFERRED EMBODIMENTS

The internet and mobile phone networks are increasingly becoming aggressive competitors with traditional radio and TV broadcasters as a media delivery systems for audio-visual programming. The bi-directional one-to-one delivery channel with each user provided by the internet, and mobile phone networks to a lesser degree, has accustomed users to a new, highly interactive relationship with media providers and other users that was not possible with the traditional broadcast services. These changes have adversely affected the economic prospect of the traditional broadcast services, but as yet have not resulted in many highly successful internet or mobile phone media delivery services.

Another significant consequence of the emergence of the internet and mobile phones as interactive media delivery systems is the increasing opportunity for individuals to be producers and hosts of programming for delivery to large audiences beyond their immediate circle of friends. This is one facet of an important social and business trend in which facilitating user-to-user and providing automated recommendations of media items has become an increasingly important marketing technique. Increasingly, recommendations of both types are being recognized as the means for creating market opportunities for media items (and other products) which may not have otherwise had an addressable market. This is theory of so-called “long-tails” markets, in which the potential market for an individual media item even with the new recommender aids may be so small that it would only generate enough revenue to support the creator, but the aggregate market for a large number of such items with small markets can be very economically valuable.

The producer and host functions in media programming were previously reserved to a cadre of professionals employed by media producers who are paid for finished programming, and by broadcasters whose business models are based on subsidizing rights licensing of the primary media content, finished programming from other producers, and the salaries of the programming professionals they employed through paid advertising. Advertisers typically pay fees to have their promotional media items broadcast in conjunction with entertainment media items that are most appealing to the consumers the advertisers believe will be most likely to purchase their products or services. Even so, advertisers expect that only a fraction of the total audience their messages reach will actually become customers. A programming model which embodies direct user-to-user communication and recommendations offers new opportunities for user-to-user marketing that advertisers are just starting to explore.

Copyrights and licensing is a key issue in the user-programmer revolution. Every creative work embodies a number of copyrights in the United States and internationally, including a performance right. The cost and complexity of obtaining the legal right for user-programmers to include copyrighted media items for which they don't already own the rights in their programming has fundamentally constrained the growth of user-produced and hosted programming for public distribution. Arguably, a cost-effective solution to the licensing challenge is the key to a successful business model based on user-produced and hosted programming.

While limited opportunities exist for individual user-programmers to broadcast selected content to others, such as internet radio or podcasting, the need remains for improved systems that will more effectively leverage direct user-to-user communication and recommendations implement new opportunities for user-to-user marketing while also addressing copyright law limitations.

The following glossary is provided for the convenience of the reader:

An advertising item is a promotional media item for which the provider of the item pays a fee to the media delivery service for transmission of the advertising item.

An ephemeral copy of a media item is a copy satisfying the terms of 17 U.S.C. §112 for sound recordings. It is a copy of a media item made and retained solely by the media delivery service only for transmission by the service, and retained for a limited time.

A media item is any item of an expressive nature, e.g. a song, a book, a newspaper, a movie, a segment of a radio program, etc. A digital media item is a media item which is embodied in the form of a computer data file that can be rendered by appropriate computational means to display the expressive content of the media item.

A promotional media item is a media item which promotes, publicizes, advertises, advances, etc. something other than the said promotional media item. A promotional media item can be of different types, e.g. a commercial advertisement, public service announcement, editorial, political endorsement, etc. Although “media item” generically refers to any of the types of media items defined here, for expressive convenience in this specification, unless explicitly stated, “media item” without other qualifiers should be understood to refer to non-promotional, digital media items.

A playlist is a sequential list of names or other specifications of media items or advertising items. A media item playlist is a playlist of media items. An advertising item playlist is playlist of advertising items. Although, “playlist” generically refers to a list which can include a mix of media items and advertising items, for expressive convenience in this specification, unless explicitly stated, “playlist” without other qualifiers should be understood to refer to a playlist consisting only of media items or advertising items as appropriate in the context of the reference.

A user-programmer is a member of the audience to which the media delivery service delivers programming and who uses the virtual studio means to compose programming consisting of media items and advertising items for delivery by the service.

A virtual studio is a means provided by a media delivery service, in some embodiments in the form of an application software program, and accessible to a user of the media delivery service, that enables the user to compose programming for transmission by the media delivery service. “Programming” here refers to content, such as media items, as distinguished from computer programming in the traditional sense. The virtual studio can include an inventory of media items and advertising items made available by the media delivery service that the user may select for inclusion in the programming composed by the user.

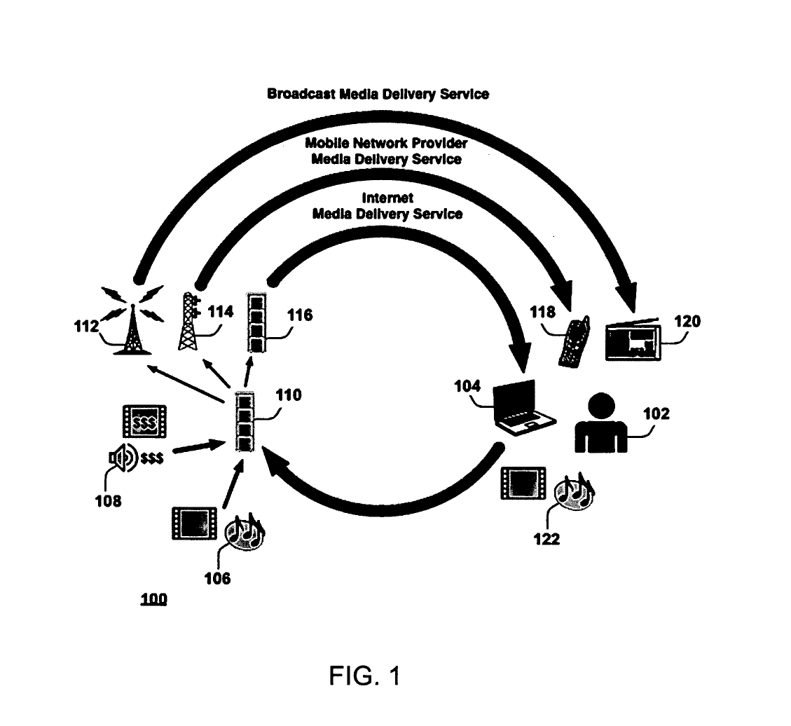

Turning now to the figures, FIG. 1 presents a graphical descriptive overview of how illustrative components of a system interact. Broadcasters who operate broadcast stations 112 that transmit to user receivers 120, mobile network providers who operate interactive data services 114 that wirelessly communicate with user handsets 118, and internet service operators who operate servers 116 that deliver content to internet-connected user computers 104, provide media delivery service capacity to users. Users 102 access these media delivery services via broadcast receivers 120, mobile phone handsets 118, and personal computers 104.

A user provides information via a personal computer 104 about his or her preferences in media items and advertising items to an audience interaction means operating on a server system 110. In some embodiments, a user may also provide this preference information using a mobile phone handset 118 via the mobile network provider 114 to the server system 110. Similarly, in other embodiments, a user may also provide this preference information using an internet-connected personal computer 104 via the internet-streaming service server 116 to the server system 110. And in yet other embodiments, a user may also provide this preference information to the server system 110 via two-way communications means such as wi-fi internet connectivity or mobile network provider connectivity incorporated in a broadcast receiver 120.

In addition to operating the audience interaction means, server system 110 also provides a virtual studio means by which users may compose programs consisting of playlists of media items 106 and either actual selections, or suggestions for selections, of advertising items 108. In some embodiments, the virtual studio means can include features to impose constraints on the selection of media items a user may include in playlists. An example is a feature that limits the user to selecting media items which satisfy the “Sound Recording Performance Complement” specification provided in 17 U.S.C. §114(j)(13) as a necessary condition for a transmission service to secure a statutory license for the performance of sound recordings. The word “means” in this description is used in its ordinary English sense rather than as it is used in the patent statute, Section 112. Where the term “means” appears in the claims, however, it is subject to construction as provided by law.

The server system 110 includes means for preparing programming consisting of media items 106 and advertising items 108, and supplying it for delivery to users 102 over channel capacity provided by broadcast 112, 120, mobile network provider 114, 118, and internet 116, 104 media delivery services. In various embodiments, the prepared programming consists of playlists of media items 106 composed by users 102 with the virtual studio means, playlists of media items generated by automated means in response to individual user or group taste preferences, and pre-composed playlists. Similarly, in some embodiments, the prepared programming consists of playlists of advertising items 108 which may be suggested or selected by users, advertising items selected by automated means in response to individual user or group characteristics including expressed preferences, or pre-selected advertising items.

The server system 110 supplies programming over a communications network to the transmission means operated by broadcasters 112, mobile network providers 114, and internet services 116. In some embodiments, the programming may be supplied in the form of playlists to media delivery services that have means for procuring the actual media items and/or advertising items in the programming for transmission. In other embodiments, the actual digital media items and advertising items comprising the programming may be supplied to the transmission means by the server system 110 directly, or by a separate server. In yet other embodiments, the digital media items and advertising items comprising the programming may be combined into a program unit composed of one or more digital files supplied over a communications network to a mobile network provider 114 or internet services 116 that delivers them in bulk form to a user device capable of receiving them.

In some embodiments, users may also supply media items 122 for inclusion in programming composed by the user in the virtual studio. These media items can include commentaries about the media items such as an on-air host might provide in broadcast radio music programming. They may also include testimonials to supplement the advertising included in programming. Ephemeral copies of these media items are maintained on the server only so long as necessary to deliver the programming.

In accordance with one aspect of the invention, the advertising items 108 may be supplied from an inventory of paid advertising maintained by the business entity operating an embodiment of the invention, or by a brokerage service such as dMarc Broadcasting (now Google, Inc.) or Third Screen Media. In some embodiments, a portion of the advertising revenues, either those paid directly to the business entity by advertisers or those paid by brokerages, may be used to defray the cost of procuring channel capacity from broadcasters 112, mobile network providers 114, or internet services 116 to transmit the programming.

In other embodiments, the programming supplied by the service may not include advertising items 108, and a broadcaster 112, mobile network provider 114, or internet service 116 may pay a fee to the business entity operating an embodiment of the invention to provide programming. In these circumstances, the business entity may also provide data about individual user or audience characteristics, including advertising preferences, that the media delivery service can use to determine the rates to charge advertisers for advertising opportunities in the programming.

Additionally, in some embodiments of the invention the server system 110 may include other features to enhance the user experience and increase the amount of user preference information gathered. One example is social networking features that allow users to learn the media interests of other users and to share their media preferences with each other. Another example are incentives such as savings and rebates offered by advertisers to users to increase the conversion rate of advertising impressions to sales. A further example might be remuneration to user-programmers based on the popularity of their programs with the user community. Yet another example might be archives of previously transmitted programming that perhaps maintain a program only for a time period permitted by the licensing terms for the media items.

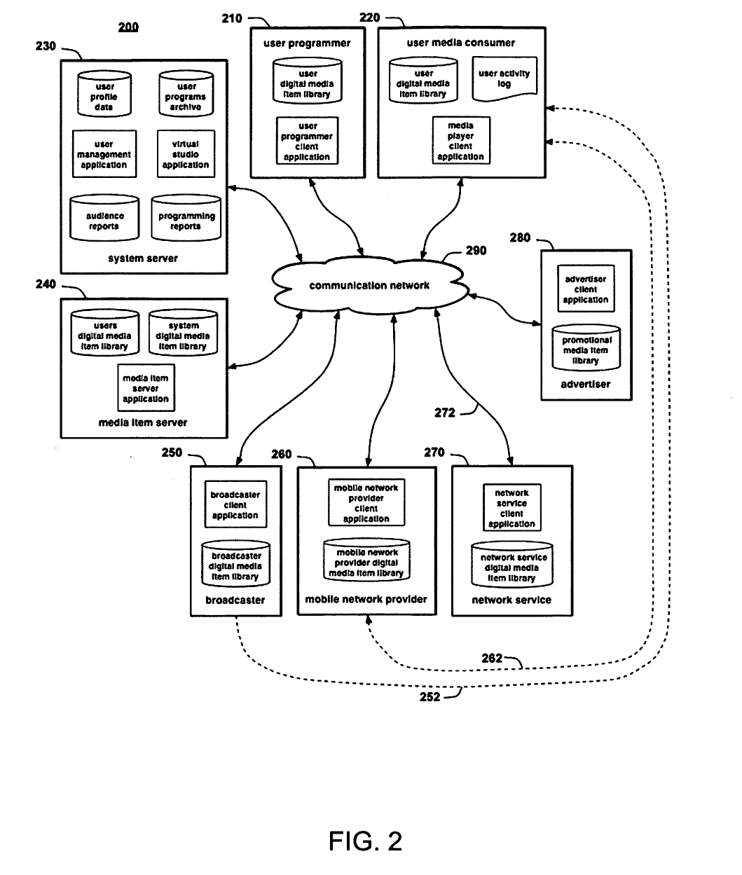

A typical system embodiment is depicted in FIG. 2. The key components interact over a communications network 290 such as the internet. Users interact with the system primarily via a user programmer component 210 and a user media consumer component 220. For an internet-based embodiment, the user-programmer component typically is a personal computer equipped with a web browser that communicates with the virtual studio application on the system server 230, and perhaps a library of digital media items the user may wish to include in a program and temporarily upload to the system server. The user media consumer component typically includes a means to access the user interaction services on the system server, and can be a personal computer equipped with a web browser or a mobile phone equipped with a web-browser or custom application providing a user interface to the system. The user media consumer component can also include a media player which plays programming such as that provided by a network-connected streaming service transmission means 270 directly over a network connection 272, by a mobile network provider service transmission means 260 over an independent communications channel 262, or a broadcast transmission means 250 over a broadcast communications channel 252.

The system server 230 hosts a user management application and the virtual studio means introduced earlier with regard to the functional role of the server 110. The user management application provides a number of functions to support users. In some embodiments these include features mediated by a web browser common on web-based business-to-consumer services such as new user account creation, user profile creation and maintenance, access to a database of music information, and social networking features that allow users to learn the media interests of other users and to share their media preferences with each other.

Preferably, media preferences are determined as an ongoing process from the aggregate of explicit and implicit expressions mechanisms mediated by the “user management application,” which in one embodiment can be implemented as a website hosted by the system server 230. Some examples of such preference expression mechanisms include:

1) Static playlist building such as that done at www.musicstrands.com website.

2) Records of the actual plays on a user's playback device, as reported through known applications.

3) Seed songs specified in a “radio” player like Pandora.

4) “Thumbs up—neutral—thumbs down” buttons provided at websites or other facilities where media item recommendations are provided.

5) Feedback from “Like it—it's okay—skip this” or similar buttons on a “radio player”.

6) “Bands/songs/albums I like right now” lists on a personal account page. In some embodiments items would be added by the user browsing a media related website and clicking “add to favorites”, and text input/completion in text input boxes.

The user profile information may include explicitly and implicitly expressed user preferences about media items and advertising items they would like to have and that have been presented to them. In other embodiments, the user management application may include a set of web-based services accessible through an application-programming interface to support application-specific clients on a user PC or embedded in a personal access device which mediate the aforementioned features, and to gather user preferences through explicit and implicit means convenient to the user.

The virtual studio also hosted by the system server 230 is one means by which users can directly produce and influence programming, including both media items and advertising, delivered by the service. In some embodiments, this is web-browser mediated web-service that allows users to compose playlists of media items. The user may either specify the actual media items and their order on the list, optionally selecting them from media items suggested by media item recommender technology that is responsive to the user's express preferences incorporated in the virtual studio service, or incorporate in part or in total playlists suggested by playlist builder technology based on the media item recommender. In some embodiments, to meet the requirements of a specific broadcaster 250, mobile network provider 260, or network-connected service 270, the system server can also be configured to use the playlist builder technology in the virtual studio to compose playlists responsive to the consensus taste of the audience members known to the system through the user interaction services, or from audience demographic information from third party suppliers such as Arbitron or Nielsen Media Research.

A similar situation exists with regard to ascertaining advertising preferences. Typically, the system would have an inventory of available advertising spots, perhaps from a broker, in analogy to the library of tracks (media items) available for users to include on playlists. Similar to the case for user media preferences, user advertising preferences can be determined explicitly or as an ongoing process mediated by the “user management application” website. Some examples of such preference expression mechanisms include the following:

1) “products/services I'm seeking right now”, “products/services I generally would like to have information about”, etc. lists on a personal account page. Typically items would be added by browsing suggestive lists on the website and clicking to add items to the list, text completion in text input boxes, and checklists of common item categories.

2) “Tell me more—not interested” buttons on media players (those can be used to later provide a user with an option to pull up more information on a web-browser anytime the user returns to the user interaction application).

3) User follow-through via the website in investigating more information about advertising items provided to him or her.

4) User advertisement browsing via the website—almost in analogy to playstreams in item 2) above for media items.

5) Demographic information (age, gender, geographic location, etc.) provided by the user.

6) Inferences about possible advertisements of interest from media items the user actually plays. One example would be how the commercial recommender for which we've filed a provisional uses the songs included in commercials, and songs in the context of which advertisers indicate they would like their commercials played to match commercials with user listening preferences.

7) Explicit expressions on the virtual studio application by user-programmers of commercials for the specific items, or types of items, they would like to have played in conjunction with their playlists.

In some embodiments, the virtual studio also includes a feature by which a user may select specific advertising items to be included in the programming in temporal proximity to the playlists they compose from an inventory maintained by the service or made known to the service by a third-party advertising broker operated advertisement server 280. In other embodiments, the user may only make general preferences known and specific advertising items responsive to those preferences selected from the known inventory according to specific constraints such as generating the greatest revenue from advertisers. In yet other embodiments, the system server may be configured to select advertising items responsive to the consensus aggregate preferences in advertising messages of audience members known to the system from the user interaction services. And in still other embodiments, the system server may be configured to select advertising items responsive to audience demographic information known to the system from the user interaction services, or from third party suppliers such as Arbitron or Nielsen Media Research.

The system server 230 supplies playlists of media items, and playlists or other information identifying the advertising items and the playlists and media items to which they should be played in temporal proximity, through the communication network 290 to the transmission means 250, 260, 270 of media delivery services with the technical means to transmit the actual media items and advertising items given knowledge of the identifying information. Some embodiments may include a digital media file server, or one or more streaming media item servers 240, to supply the actual media items and advertising items in the form of digital media files, or media streams, to the transmission means 250, 260, 270 of media delivery services that do not have a library of digital media items included in the programming or access to another source that can supply them.

The media transmission means of a broadcaster 250, a mobile network provider 260, or an internet service 270 interact with the other components of the system using standard internet technologies for communicating data files and digital media packet streams. Each of these media transmission components includes a client application which communicates with the system server 230 to receive programming in the form of playlist files, digital media files, or digital media packet streams as required by the specific transmission means.

An instance of the advertising server 280 in various embodiments may be operated by the entity operating an embodiment of the invention, or by a third-party advertising brokerage such as dMarc Broadcasting, Inc. This server maintains an inventory of advertising items available for inclusion in the programming of a media delivery service. In some embodiments, the server 280 provides a listing of available inventory to the programming means hosted on the system server 230, and in other embodiments responds to queries from the system server about the availability of advertising items meeting specific criteria. The advertising items can be identified by keywords that identify their content in a meaningful way, by the demographic characteristics of the intended audience for the advertising item, or by similar data elements describing media items used in the advertising item. On request, the advertising item server provides the actual advertising items through the communication network 290 to the streaming server 240 and the transmission means 250, 260, and 270 as digital media files, or digital media packet streams as required by the specific media item server or transmission means.

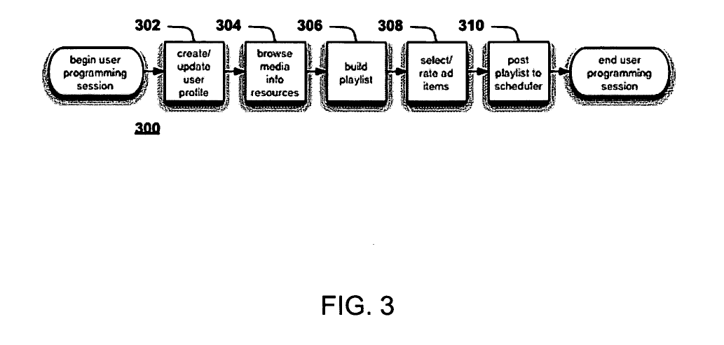

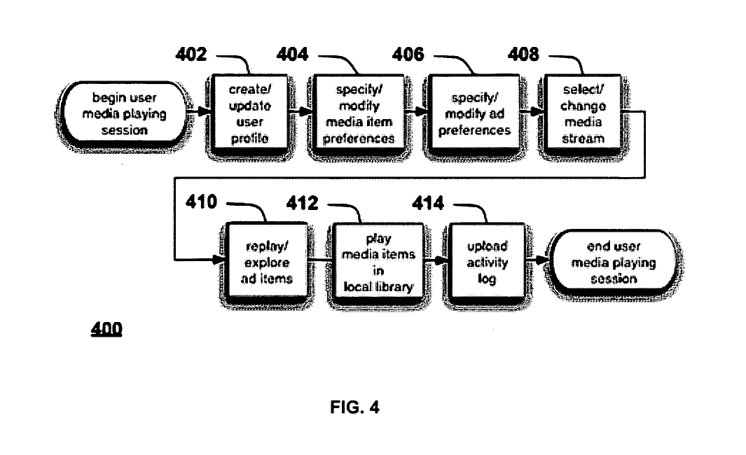

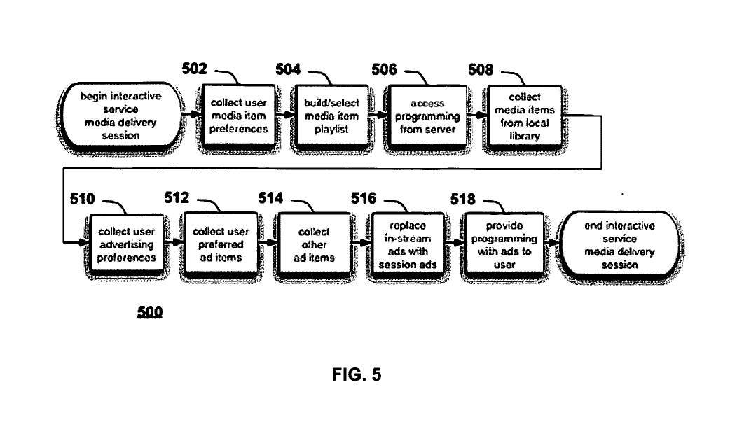

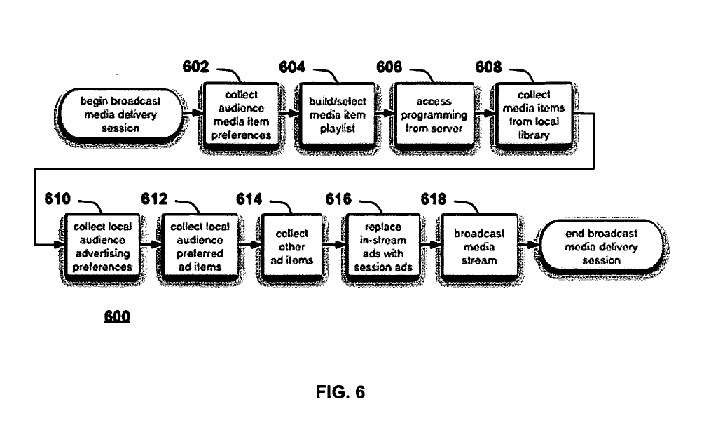

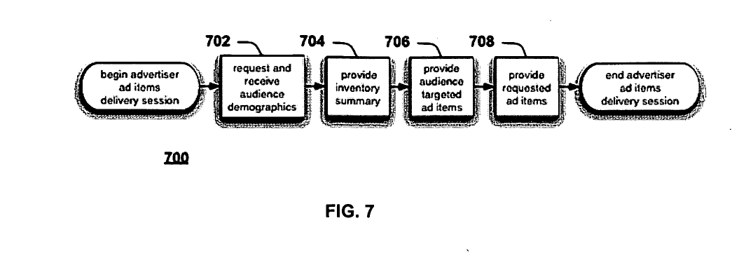

FIG. 3, FIG. 4, FIG. 6, and FIG. 7 are generalized flow diagrams of the user programmer 210, user media consumer 220, the transmission means of the broadcaster 250, and the advertiser server 280, components, respectively, of illustrative embodiments. FIG. 5 is an a generalized flow diagram of a transmission means of the mobile network provider 260 and the network service 270 components. Each of these is described next.

As shown in FIG. 3, a user programmer 210 interacts with the virtual studio means on the system server 230 over the communication network 210 via a web-browser or application-specific client in several general operations implemented using standard technologies for building interactive internet websites, and depicted in a typical sequence. In a first encounter with the system, a user registers (302) with the system and creates a user profile; in subsequent encounters a user may optionally update information in the profile. In various embodiments the profile can contain basic demographic information about the user, general preferences in media items, and in advertising items. Once known to the system, and having initiated a session, the user can interactively browse (304) the media item information resources through the user interaction means which is also hosted by the system server 230. The user can also choose (306) to create a playlist by, for example, selecting media items indicated to the user through the browsing activity 304 as being available for inclusion in a playlist, by using automated media item selection and playlist building means in the virtual studio, or by indicating and uploading media items to the virtual studio. The user can also explicitly select or indicate (308) preferences for advertising items to be played in temporal proximity to the media items when the playlist is performed. When the playlist is composed, the user then activates the virtual studio functionality to post the playlist to the system server to be scheduled for transmission.

User media playing sessions have multiple embodiments whose specific details are determined by the transmission means 112, 114, or 116. FIG. 4 depicts the general operations in a media playing session over an interactive transmission means, and implemented using standard technologies for building interactive services for the transmission means. As in operation 302 of the user programming session 300, the user can create or update (402) a user profile. In some embodiments a user may anonymously operate some or all of the user interaction service means without registering and creating a profile. As a media playing session can involve the playing of media items responsive to the user's preferences in media items, the user can specify or modify (404) explicit expressions of those preferences in some manner, such as by selecting representative media items or by selecting descriptive keywords included in an index associating keywords with media items maintained by the service. Similarly, the user can specify or modify (406) preferences in advertising items the user would most like to receive in the programming provided.

Having provided the system with as much information about the user's preferences in media items and advertising items, the user then activates (408) the performance of media items by the system. In some embodiments, a sequence of media and advertising items specified by a playlist may be performed in streaming fashion so that the user can only end the performance or perhaps cause the media player to switch to the performance of another sequence of media and advertising items. In other embodiments, a set of media and advertising items embodied in a set of one or more digital files may be transmitted in bulk to the user media player.

During or after the performance of the programming, the user may further explore (410) the advertising items included in the performance. In some embodiments the user may pause the performance, or return to an earlier point in the performance, to replay an advertising item. In other interactive embodiments, additional information can be presented to the user on the media player device simultaneously or subsequent to the performance that the user may explore during or after the performance. In yet other non-interactive embodiments, the performance may include content that directs the user to further information about advertising items available through the user interaction services hosted on the system server 230.

Many media player devices include means for storing and playing media items from a local library of media items. For users accessing the media delivery service with such devices, rather than playing programming transmitted by the media delivery service, the user can play (412) media items from the local library. In some embodiments, users can also play programs of media items and advertising items previously provided as digital items in bulk form by the media delivery service.

In one embodiment of the invention, a user media players 220 in some embodiments can include a feature for logging the media items a user plays and other limited user behaviors such as switching between media streams, pausing the media player, or replaying or skipping media items. This logged user activity data contains implicit information about user preferences. During a user media playing session this activity data is uploaded (414) to the user interaction services hosted on the system server 230.

For embodiments in which a performance is provided by a non-interactive means such as broadcast transmission means 112, user interaction through the user interaction services hosted on the system server 230 and accessed via the communication network 290 through another device such as a personal computer 104 or a mobile phone 118, may include some or all of the steps in the user media playing session process 400 except that of actually selecting and playing media items 408 (i.e. 402, 404, 406, 410, 412, and 414). Furthermore, users may access the social networking features that allow them to learn the media interests of other users and to share their media preferences with each other such during a user media playing session in embodiments which include them.

FIG. 5 depicts the general operations in the delivery of programming by a interactive media delivery service such as 114 and 116, that provides programming via an interactive transmission means such as 260 or 270, respectively. In this case, the transmission service effectively has a private bi-directional communication channel 262 or 272, respectively, with each user that permits delivery of personalized programming to that user. A user initiates a media delivery session by establishing communication with the transmission means using standard communication protocols appropriate for the transmission means and the user's media player 220. The transmission means client application provides identifying information for the requesting user through the communication network 290 to the system server 230 and requests that the system server provide programming for that user. The system server coordinates the delivery of programming from the system components through the communication network in the manner described previously with reference to the system diagram FIG. 2, and further described below, to the transmission means which in turn transmits the programming to the user.

To compose programming suitable for the requesting user, the system service accesses (502) the user's media item preferences it has stored and uses automated playlist building means to build (504) a playlist of media items responsive to those preferences. Alternatively, in some embodiments, a user may request that a playlist archived by the server for a specific media delivery session; in such case the transmission means client application communicates identifying information for that playlist to the system server and selects that playlist for the session rather than build a playlist responsive to the user's media item preferences. The system server 230, and additionally in some embodiments the media item server 240, interoperate (506) with the transmission means client application to provide the media items on the playlist which are not available from any local library of media items available to the transmitter means, and the transmitter means client application accesses (508) those media items available from any local library.

In a similar manner, the system server accesses (510) the user's advertising preferences to provide (512) advertising items of greatest interest to the user in the programming. In some embodiments and some sessions, the system server may also select (514) advertising that is not directly targeted in response to the user preferences, but rather based on criteria determined by the system operator including demographic characteristics of the user. In some embodiments, programming composed by other users in the virtual studio may include advertising items selected or suggested by the user-programmer, as may third party supplied programming. As for the media items, the system server 230, and the advertising item server 240, interoperate (512, 514) with the transmission means client application to provide the advertising items to the transmitter means, and to replace (516) advertising supplied in the programming with session specific advertising. The programming media items and advertising items are then transmitted (518) to the user by the transmission means.

FIG. 6 depicts the general operations in the delivery of programming by a broadcast media delivery service 112 that provides programming via an non-interactive transmission means such as 250. In this case, the transmission service effectively has a one-way broadcast communication channel to an audience of users. Rather than deliver personalized programming to each user, a broadcaster can only deliver programming responsive to the consensus taste of the audience, to the extent the broadcaster can determine that consensus taste. One significant advantage in one embodiment of the invention is that the inclusion of the user interaction services and the virtual studio means hosted by the system server afford means for determining consensus tastes in media items and advertising items of a broadcast audience.

Programming is composed for a broadcast audience, and delivered to the broadcast transmission means for transmission, in a manner that is essentially analogous to the composition and delivery of programming to a individual user by an interactive service. However, the operations of accessing (502, 510) user media item and advertising preferences performed by the system server are instead analogous operations in which consensus audience preferences are inferred (602, 610) from the individual preferences of users who explicitly indicate in their profile that they are, or in other embodiments that the server infers from demographic information in their profile there is a high likelihood that they are, members of the broadcaster's audience.

FIG. 7 depicts the general operations in the delivery of advertising items by which an advertiser 108 provides these items from a server 280 through the communication network 290 to the system server 230 in some embodiments, or directly to the transmission means 250, 260, or 270 in other embodiments. The advertising items supplied for inclusion in the programming transmitted via broadcast means 250 are selected so as to be generally responsive to the expressed and/or inferred consensus preferences of the broadcast audience. The advertising items supplied for inclusion in programming transmitted via interactive transmission means 260 or 270 are selected to be generally responsive to the expressed and/or inferred consensus preferences of the individual recipient of the transmitted programming.

In some embodiments, the advertising item client application hosted on the advertising server 280 implicitly or explicitly requests (702) audience demographic information from the system server 230 and transmits (704) a summary of the available advertising items responsive to that demographic information to the server. In some embodiments, the advertising server then supplies (706) advertising items generally responsive to the information supplied by system server, while in other embodiments the advertising server may supply (708) items specifically selected by the system server from that inventory. In yet other embodiments, the system server might request that the advertising server supply (704) an inventory of available advertising items responsive to the programming recipient's preferences, specified by some criteria such as product category or product supplier, and the advertising server would similarly supply (706, 708) advertising items. In either case, the demographic and preference information supplied by the server may be for a specific individual recipient of the transmitted programming, or consensus information for an audience composed of multiple individuals.

As provided for in the descriptions above of the means by which media items are provided for inclusion in the programming transmitted by the transmission means 250, 260, or 270, in some embodiments the advertising server may supply the advertising items via the communications network 290 directly to the transmission means. In other embodiments the advertising server may supply the advertising items via the communications network 290 to the system server 230 or to the media item server 240 for retransmission to the transmission means.

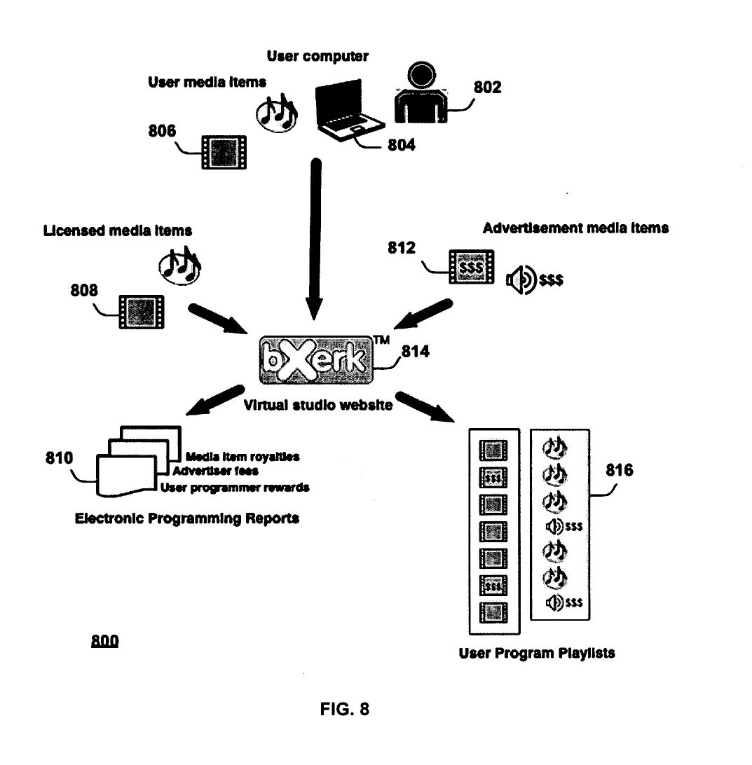

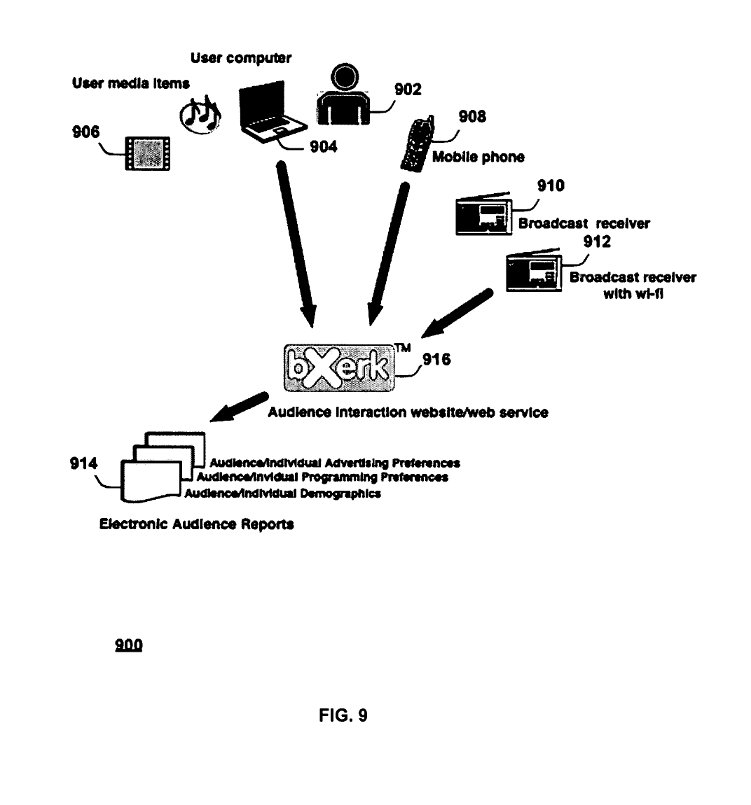

The means by which users produce programming for transmission, and communicate their preferences in media items and advertising items, are graphically depicted further in FIG. 8 and FIG. 9, respectively. As shown in FIG. 8, a user 802 interacts with the system server 230 that hosts the virtual studio application 814 to produce programming for transmission by the transmission means 250, 260, or 270. In various embodiments, this communication is mediated by a personal computer 804, a mobile phone or a wi-fi enabled media player capable of establishing communications ultimately with the virtual studio application server 814. The virtual studio application presents the user with information resources about the media items 808 the operator of the service has licensed to make available for inclusion in user-produced programming, and a query means for determining the availability of media items responsive to user-specified criteria. In some embodiments, the virtual studio application also provides the user with similar means for selecting advertising items 812. In other applications users are only provided with a means for specifying preferences in advertising items.

Using the aforementioned features of the virtual studio application, a user selects media items 808, and optionally advertising items 812, and composes them into playlists 816 for transmission. In some embodiments, the virtual studio application may include means to guide the user in selecting and sequencing media items so that the playlists satisfy compositional constraints, such as the “sound recording performance complement” required to qualify for the statutory performance license mandated by 17 U.S.C 114. In other embodiments, the virtual studio may include means to guide the user in selecting media items and advertising items so that the net cost of performing the playlist, for instance the difference between the total licensing fees for the media items less the revenues generated by the advertising items, satisfies a desired constraint. Additionally, some embodiments may include a means to allow users to upload ephemeral copies of media items 806 for inclusion in a playlist and performance in a transmission.

As described previously, the composed playlists are then scheduled for transmission by the system or by request of other users. In some embodiments the playlists may also be archived for re-transmission. Finally, the virtual studio also produces reports 810 for display and submission to appropriate partners. Examples of these reports include a summary of licensing fees owed to rights holders, fees due from advertisers, and rewards offered to user programmers based on the popularity of their programs.

FIG. 9 presents a similar graphical depiction of the means by which a user 902 employees a user interaction application website 916 to communicate preferences in media and advertising items. In various embodiments, this communication is mediated by a personal computer 904, or a mobile phone 908, a wi-fi enabled media player, or a broadcast receiver with additional two-way communication means 912 capable of establishing communications ultimately with the system server 230 hosting the user interaction application server 916.

As described previously, the user interaction application provides one more means for users to express their preferences in media items and advertising items. In some embodiments this includes explicit means for allowing users to build sequential playlists of preferred media items, to construct unstructured collections of preferred and disliked media items and performers, and to indicate approval or disapproval of media items or performers presented to the user. The user interaction application can include similar means for users to explicitly express preferences in advertising items so as to increase the probability that the user will be presented with advertising items of most interest.

In addition to providing these explicit means, the user interaction application 916 also can include implicit means for users to express their preferences. In some embodiments, these implicit means include communicating with a client application on a personal computer 904, or a mobile media player such as mobile phone 908, to log sequences of items from a local library 906 of media items on the device. In other embodiments, this includes a similar client application on a broadcast receiver equipped with a means for communicating with the user interaction application that logs what broadcasts and advertising the user chooses to let play. Each of the aforementioned client applications can also provide explicit means for a user to indicate a preference, dislike, or neutral feelings about each media item as it is played.

Finally, in some embodiments the user interaction application 916 provides social networking features that allow users to learn the media interests of other users and to share their media preferences with each other. These social networking features may similarly produce data that may be processed to derive explicit and implicit expressions of user preferences and dislikes for media items and advertising items.

The user interaction application 916 provides information used by the program building processes 500 and 600 hosted on the system server 230. In various embodiments, these processes construct the personalized programming delivered to individual users by mobile provider transmission means 260 and network transmission means 270, and the programming responsive to consensus audience preferences delivered by broadcast means 250, respectively. The data delivered to the program building processes 500 and 600 by the user interaction application 916 can include individual and audience media item preferences, individual and audience advertising item preferences, and individual and audience demographics.

Although the preferred embodiment and variations thereof have been described and illustrated above, those skilled in the art will appreciate that various modifications and changes can be made that do not depart from the spirit and scope of the invention. Accordingly, the scope of the present invention is defined and limited only by the following claims:

1. A method of creating media programming for electronic broadcast to media consumer users comprising the steps of:
(a) providing a software application for use by a user-programmer in creating a digital media program;
(b) in the software application, assembling a playlist comprising at least one media item and at least one advertising item all selected by the user-programmer to form the digital media program;
(c) in the software application, automatically identifying each of the selected media items that comprises a sound recording;
(d) in the software application, for each of the identified sound recordings, automatically determining whether either of the user-programmer or the intended media delivery service has a sound performance license from the corresponding copyright proprietor that permits digital audio transmission of the sound recording; and
(e) if any of the identified sound recordings is not so licensed, guiding the user in selecting and sequencing media items so that the resulting playlist satisfies a predetermined compositional constraint.

2. A method according to claim 1 wherein the predetermined compositional constraint comprises compliance with the requirements of the sound recording performance complement provided by the United States Copyright Act, whereby transmission of the digital media program will avoid copyright infringement.

3. A method according to claim 1 wherein the user-programmer selects media items for inclusion in the playlist responsive to media consumer preferences determined as an ongoing process from an aggregate of explicit and implicit preference expression mechanisms.

4. A method according to claim 1 wherein the user-programmer selects advertising media items for inclusion in the playlist responsive to media consumer advertising preferences determined as an ongoing process from an aggregate of explicit and implicit preference expression mechanisms.

5. A method according to claim 1 wherein the user-programmer selects advertising media items for inclusion in the playlist based on the selected media items.
